(19) United States
(12) Patent Application Publication
(10) Pub. No.: US 2021/0307321 A1
(43) Pub. Date: Oct. 7, 2021

(54) CAPSULE SUSPENSIONS WITH AGROCHEMICAL ACTIVE INGREDIENTS

(71) Applicant: Bayer Aktiengesellschaft, Leverkusen (DE)

(72) Inventor: Arianna MARTELLETTI, Sulzbach im Taunus (DE)

(21) Appl. No.: 17/264,083

(22) PCT Filed: Jul. 30, 2019
(86) PCT No.: PCT/EP2019/070413

§ 371 Date: Jan. 28, 2021

(30) Foreign Application Priority Data
Jul. 31, 2018 (EP) 18186733.4

(51) Int. Cl. A01N 25/28; A01N 43/40; A01N 43/80; A01N 25/02; A01N 25/08

(52) U.S. Cl. CPC A01N 25/28; A01N 43/40; A01N 25/08; A01N 25/02; A01N 43/80

(57) ABSTRACT

The invention relates to capsule suspensions of agrochemical active ingredients, which are difficult to formulate, i.e. which either lack solubility or chemical stability in such when formulated in such agrochemical formulations.

The invention relates to capsule suspensions of agrochemical active ingredients, which are difficult to formulate, i.e. which either lack solubility or chemical stability when formulated in such agrochemical formulations.

Agrochemical compositions with Diflufenican and Isoxaflutole as active ingredient are well known. However, Difufenican has a very low solubility in non-water miscible solvents, thus it is difficult to prepare formulations with a sufficient loading.

While Isoxaflutole has no such solubility problem, it is chemically instable in such formulations, in particular if the pH is >5, more particular if the pH is >4.

Therefore, there is a need for formulations with high load of Diflufenican and chemically stable Isoxaflutole.

To overcome the above problems a capsule suspension of an oil dispersion was prepared, wherein the active ingredient, suspended in a non-water miscible carrier (preferably Solvesso® 200 ND from ExxonMobil/Miglyol® 812 N from Cremer Oleo) is encapsulated in form of suspended particles.

Capsule suspension formulations preparation methods are well known as described for example in EP 3 112 016 A1 or WO 2018024839 A1.

Hence, to solve the above outlined problem, the present invention is directed towards capsule suspensions comprising an agrochemical active ingredient comprising a polyurea-shell and a core,

wherein the core contains the active ingredient selected from the group of diflufenican and isoxaflutole,

wherein the active ingredient is present in the form of suspended particles alone or on a solid carrier.

In a preferred embodiment, the solid carrier is highly dispersed, amorphous silicon dioxide (silica).

Moreover, the capsule suspensions have an average particle size D90 of 1 to 60 μm. Further, the capsule suspensions have a polyurea shell comprising a polyisocyanate and a polyamine in polycondensed form.

In a further preferred embodiment, the core comprises, along with the active ingredient, a water-immiscible liquid carrier, which more preferably is selected from the group comprising aromatic hydrocarbons, mineral oil, naphthaline free mineral oil, fatty acids glycerides, caprylic or capric triglycerides and neutral vegetable oil, as well as mixtures thereof.

Air milled Diflufenican was suspended in a non-water miscible carrier and a capsule suspension was prepared by known methodologies via encapsulation in water. Particle size D90 has to be about 30 μm (micro meter) otherwise the capsules will not close. Isoxadifen was either air-milled or prepared on a carrier material (for example as WP95, using Sipernat® 22S, available from Evonik), then encapsulated via known methods in water. The choice of the carrier is important, since not every carrier material is leading to a physically stable capsule suspension.

Particle size is measured according to CIPAC (CIPAC=Collaborative International Pesticides Analytical Council; www.cipac.org) method MT 187 determined as D50 respectively D90=active ingredient particle size (laser diffraction 50%, respectively 90% of overall volume particles). The mean particle size denotes the D50 value.

For example, rapeseed oil methyl ester (RME) as liquid carrier gives no satisfactory result, while Solvesso® 200 ND and Miglyol® 812 N allow to prepare a physically stable capsule suspension.

In one embodiment, the capsule suspensions according to the instant invention have a polyurea-shell and a core, wherein the core contains diflufenican or isoxaflutole in form of suspended particles alone or on a solid carrier (preferably highly dispersed, amorphous silicon dioxide, e.g. Sipernat® 22® S from Evonik), wherein further preferred, the active ingredient is isoxaflutole.

The core comprises a water-immiscible liquid carrier (preferably an aromatic hydrocarbon, e.g. ND 150-210—305, Mineral oil, Naphthaline free as Solvesso® 200 ND from ExxonMobil or fatty acids glycerides, caprylic or capric triglycerides or neutral vegetable oil, as Miglyol® 812 N (from Cremer Oleo).

The aqueous capsule suspension according to the present invention comprises:

a) diflufenican or isoxaflutole as active ingredient (preferably micronized or air milled with 5 wt (based on the amount of active ingredient and solid carrier) of a solid carrier, preferably highly dispersed, amorphous Silicon dioxide,

b) Polyisocyanate

c) Diethylentriamine as 50% solution in water

d) Polyvinylalcohol, about 88% saponified Polyvinylacetate

e) Liquid carrier, preferably selected from the group of aromatic hydrocarbons, a mixture of fatty acids glycerides, caprylic or capric triglycerides, and neutral vegetable oil

f) Rheological additives (rheological modifier)

g) Poly organic acid (polyprotic acid)

h) Formulation auxiliaries (other formulants, e.g. antifreeze, biocides, antifoam)

i) Demineralized water.

The aqueous capsule suspension comprises in a preferred embodiment:

a) 4 to 30 wt % of diflufenican or 4 to 30 wt % isoxaflutole as active ingredient (preferably micronized or air milled with 5 wt % (based on the amount of active ingredient and solid carrier) of a solid carrier, preferably highly dispersed, amorphous Silicon dioxide,

b) 2-5 wt % of Polyisocyanate

c) 0.7-4 wt % Diethylentriamine as 50% solution in water

d) 3-10 wt % Polyvinylalcohol, about 88% saponified Polyvinylacetate

e) 10-45 wt % of a liquid carrier, preferably selected from the group of aromatic hydrocarbons, a mixture of fatty acids glycerides, caprylic or capric triglycerides, and neutral vegetable oil

f) 0,02-0.3 wt % of one or more rheological additives (rheological modifier)

g) 0,4-4 wt % of a poly organic acid (polyprotic acid)

h) 5-10 wt % of commonly used formulation auxiliaries (other formulants, e.g. antifreeze, biocides, antifoam)

i) Demineralized water ad 100 wt %.

In a more preferred embodiment the aqueous capsule suspension comprises:

a) 5 to 25 wt % of diflufenican or 5 to 25 wt % isoxaflutole as active ingredient (preferably micronized or air milled with 5% w % (based on the amount of active ingredient and solid carrier) of a solid carrier, preferably highly dispersed, amorphous Silicon dioxide,

b) 2.5-4 wt % of Polyisocyanate

c) 1.5-2.5 wt % Diethylentriamine as 50 wt % solution in water

d) 4-7 wt % Polyvinylalcohol, about. 88% saponified Polyvinylacetate

e) 15-40 wt % of a liquid carrier, preferably selected from the group of aromatic hydrocarbons, a mixture of fatty acids glycerides, caprylic or capric triglycerides, and neutral vegetable oil

f) 0,05-0.2 wt % of one or more rheological additives (rheological modifier)

g) 0,5-3.0 wt % of a poly organic acid (polyprotic acid)

h) 6-10 wt % of commonly used formulation auxiliaries (other formulants, e.g. antifreeze, biocides, antifoam)

i) Demineralized water ad 100 wt %.

In an especially preferred embodiment the capsule suspension comprises and more preferably consist of:

a) 5 to 20 wt % of diflufenican or 5 to 20 wt % isoxaflutole as active ingredient (preferably micronized or air milled with 5 wt % (based on the active ingredient) of a carrier, preferably highly dispersed, amorphous silicon dioxide, and more preferably used as WP95).

b) 3.15 wt % of Polyisocyanate

c) 1.98 wt % Diethylentriamine as 50% solution in water

d) 5.4 wt % Polyvinylalcohol, ca. 88% saponified Polyvinylacetate

e) 20-35 wt % Aromatic hydrocarbon, e.g. ND 210—305 CAS no 64742-94-5 or a mixture of fatty acids glycerides, caprylic or capric triglycerides, neutral vegetable oil

f) 0,07 to 0.15 wt % of one or more rheological additives (rheological modifier)

g) 0,7-2 wt % of a poly organic acid (polyprotic acid)

h) 7-9 wt % of commonly used formulation auxiliaries (other formulants, e.g. antifreeze, biocides, antifoam)

i) Demineralized water ad 100 wt %.

In a preferred embodiment the active ingredient is diflufenican.

In another preferred embodiment the active ingredient is isoxaflutole.

In one embodiment the active ingredient is used as WP95 (wettable powder), wherein the active ingredient is combined with the carrier.

Further, preferably the rheological modifier is xanthan gum.

Further, preferably the polyorganic acid is citric acid.

In one embodiment the liquid carrier e) is an aromatic hydrocarbon.

In alternative embodiment the liquid carrier e) is a mixture of fatty acid glycerides, preferably of caprylic and/or capric triglycerides.

In a further preferred embodiment of the above described embodiments, the content of active ingredient a) is from 5 to 10 wt %.

A rheological modifier f) is an additive that when added to the formulation at a concentration that reduces the gravitational separation of the dispersed active ingredient during storage results in a substantial increase in the viscosity at low shear rates. Low shear rates are defined as 0.1 s-1 and below and a substantial increase is greater than ×2 for the purpose of this invention. The viscosity can be measured by a rotational shear rheometer.

Suitable rheological modifiers f) by way of example are:
Polysaccharides including xanthan gum, guar gum and hydroxyethyl cellulose and Hydroxypropylmethyl cellulose (HPMC). Examples are Kelzan®, Rhodopol® G and 23, Satiaxane® CX911 and Natrosol® 250 range and Vivapur® K15M.
Clays including montmorillonite, bentonite, sepiolite, attapulgite, laponite, hectorite. Examples are Veegum® R, Van Gel® B, Bentone® CT, HC, EW, Pangel® M100, M200, M300, S, M, W, Attagel® 50, Laponite® RD,
Fumed and precipitated silica, examples are Aerosil® 200, Sipernat® 22.

Preferred are xanthan gum, montmorillonite clays, bentonite clays and fumed silica.

Particularly preferred the rheological modifier is xanthan gum.

Suitable other formulants (formulation auxiliaries g)) are preferably selected from biocides, antifreeze, colorants, pH adjusters, buffers, stabilisers, antifoam substances, antioxidants, inert filling materials, humectants, crystal growth inhibitors, micronutirients by way of example are:

Suitable antifoam substances are all substances which can customarily be employed in agrochemical agents for this purpose. Silicone oils, silicone oil preparations are preferred. Examples are Silcolapse® 426 and 432 from Elkem Silicones, Silfoam® SRE and SC132 from Wacker, SAGO 1572 and SAGO 30 from Momentive [Dimethyl siloxanes and silicones, CAS No. 63148-62-9]. Preferred is SAGO 1572.

Possible preservatives are all substances which can customarily be employed in agrochemical agents for this purpose. Suitable examples for preservatives are preparations containing 5-chloro-2-methyl-4-isothiazolin-3-one [CAS-No. 26172-55-4], 2-methyl-4-isothiazolin-3-one [CAS-No. 2682-20-4] or 1.2-benzisothiazol-3(2H)-one [CAS-No. 2634-33-5]. Examples which may be mentioned are Preventol® D7 (Lanxess), Kathon® CG/ICP (Dow), Acticide® SPX (Thor GmbH) and Proxel® GXL (Arch Chemicals).

Suitable antifreeze substances are all substances which can customarily be employed in agrochemical agents for this purpose. Suitable examples are propylene glycol, ethylene glycol, urea and glycerine.

Possible colorants are all substances which can customarily be employed in agrochemical agents for this purpose. Titanium dioxide, carbon black, zinc oxide, blue pigments, Brilliant Blue FCF, red pigments and Permanent Red FGR may be mentioned by way of example.

Suitable stabilizers and antioxidants are all substances which can customarily be employed in agrochemical agents for this purpose. Butylhydroxytoluene [3.5-Di-tert-butyl-4-hydroxytoluol, CAS-No. 128-37-0] is preferred.

The poly organic acid g) (i.e. polyprotic acid) preferably is selected from the group comprising oxalic acid, malonic acid, succinic acid, adipic acid, maleic acid, fumaric acid and citric acid as well as mixtures thereof. More preferred the polyprotic acid is citric acid.

The formulations of the encapsulated active ingredients are especially useful for application in soybean, in particular post-emergent to reduce phytotoxicity, wherein post-emergent refers to the emergence of weeds.

Materials used and terms

The terms used in the examples below denote:

| | |
|---|---|
| Diflufenican | 2′,4′-Difluoro-2-(a,a,a-trifluoro-m-tolyloxy)nicotinanilide |
| | (Bayer AG) |
| Isoxaflutole | 5-cyclopropyl-4-(2-methylsulfonyl-4- |
| | trifluoromethylbenzoyl)-isoxazole (Bayer AG) |
| Isoxaflutole WP95 | air milled isoxaflutole with the aid of an inert carrier, Sipernat ® |
| | 22S, which is used to avoid sticking of Isoxaflutole on the walls |
| | of the mill, wherein the ratio is 5 wt % Sipernat ® 22S, 95 wt % |
| | isoxaflutole |
| Solvesso ® 200 ND | Aromatic hydrocarbon ND 210-305, Mineral oil, |
| | ExxonMobil, Naphthaline free |
| Desmodur ® 44 V 20 L TK 44.4 | 44.4% of Desmodur ® 44V20L = Polymeric MDI, Covestro AG, |
| | Functionality 2.7 in Desmodur ® T80 = Diisocyanate, |
| | Functionality 2.0, Covestro AG, Basis Toluendiisocyanate - |
| | stock solution prepared in the laboratory |
| Desmodur ® 44V20L | Diphenylmethane diisocyanate, isomers and homologs, Polymeric MDI, |
| | Covestro AG, Functionality 2.7, CAS Number 9016-87-9 |
| Desmodur ® T80 | Diisocyanate, Functionality 2.0, CovestroAG, Basis Toluendiisocyanate |
| Diethylentriamine MX 50 | DETA, Diethylentriamine, Sigma-Aldrich, 50% in water - stock solution |
| | prepared in the laboratory |
| Kuraray Poval ® 26-88 MX 10 | Polyvinylalcohol from Kuraray, ca. 88% saponified |
| | Polyvinylacetate, 10% in water, with 0.2% of Silcolapse ® 426 R - |
| | stock solution prepared in the laboratory |
| Kuraray Poval ® 26-88 | Polyvinylalcohol from Kuraray, ca. 88% saponified |
| | Polyvinylacetate |
| Desmodur ® N3300 | trimer of an alipahtic Polyisocyanate on Basis of HDI, |
| | Functionality 3.5; free monomer Isocyanate < 0.5% (Covestro AG) |
| Desmodur ® N3200 | solvent free aliphatic polyisocyanate resin based on hexamethylene |
| | diisocyanate (HDI), functionality 3.5, low viscosity (Covestro AG) |
| Desmodur ® N3400 | Aliphatic polyisocyanate based on HDI uretdione, functionality 2.5, |
| | very low viscosity (Covestro AG) |
| Silcolapse ® 426 R 30% | Aqueous emulsion of Polydimethylsiloxane (Elkem Silicones) |
| Citric acid, | anhydrous poly organic acid |
| Rhodopol ®G | Xanthan gum, Heteropolysaccharide (Solvay) |
| Reax ® 88A | Sodium ligninsulfonate, low pH (Ingevity) |
| Hexamethylenetriamine MX50 | Sigma-Aldrich, 50% in water - stock solution prepared in the |
| | laboratory |
| Reax ® 88 B | Sodium ligninsulfonate, low pH (Ingevity) |
| Miglyol ® 812 N | Fatty acids glycerides, mixture of caprylic acid and capric |
| | acid triglycerides, neutral vegetable oil |
| Desmodur ® T 80 MX 73.4 | 73.40% w/w, Diisocyanate, Functionality 2.0, Covestro AG, Basis |
| | Toluendiisocyanate Desmodur T 80 in hexamethylendiisocyanate - stock |
| | solution prepared in the laboratory |
| Hexamethylendiisocyanate | aliphatic C6 isocyanate (Aldrich) |
| SIPERNAT ® 22 S | highly dispersed, amorphous Silicon dioxide (Evonik) |
| Rapeseed oil methyl ester | Rapeseed oil methyl ester, C16-18 and C18-unsaturated (Syskem) |

General procedure for the preparation of capsules suspensions with suspended active ingredient in a water non-miscible carrier:

The active ingredient was suspended in a water non-miscible carrier, and to this solution was added the isocyanate. The mixture is dispersed with gentle stirring. Kuraray Poval® 26-88 MX10 was mixed with water in a separate vessel under gentle stirring.

The oil dispersion with isocyanate phase was added to the water phase and the emulsion prepared by use of a Ultra Turrax (Rotor-Stator System) used at 18,000 U/min for 3 minutes, wherein special attention is payed not to include air. The resulting homogeneous emulsion was transferred to a 3-necked flask, the base was added under stirring (500 U/min) and the slurry was heated up at 50° C. within 1 h and held 4 h at this temperature. At the end after slow cooling quenching was done with 30% aqueous Ammonia solution (Method A).

In an alternative method, slurry was held at 50° C. for 3,5 h, then 30% aqueous Ammonia solution was added, the mixture kept for 0,5 h and cooled down to room temperature (Method B). To avoid settling 0,1% by weight Rhodopol® G was added post processing with stirring. At the end the pH is adjusted with anhydrous citric acid to pH 7.0 (for diflufenican) or pH 4.5 (for isoxaflutole); (if not otherwise indicated in the present specification, preferably the pH may have a deviation of +−0.1).

Examples of capsule suspension with diflufenican as active ingredient:

For all examples: Diflufenican active ingredient was air milled and dried prior to use to a particle size of <=10 μm (Particle size distribution: 90%, laser diffraction in a clear aqueous 0,3% surfactant solution).

With this method a capsule suspension of diflufenican or isoxaflutole suspended in a non-water carrier with a loading of 100-200 g/L can be prepared. The result is a milky-white odorless capsule suspension formulation. See Table 1 with different examples,

TABLE 1

| type | Component in % w/w | Ex 1 | Ex 2 | Ex 3 | Ex 10 |
|---|---|---|---|---|---|
| A | Diflufenican | 20 | 9.62 | 9.62 | 9.62 |
| B | Desmodur ® 44 V 20 L TK | | 3.15 | | |
| | 44.4 | | | | |
| B | Desmodur ® T 80 MX | | | | 3.15 |
| | 73.4 | | | | |
| C | Diethylentriamine MX | 1.98 | 1.98 | 1.98 | 1.98 |
| | 50 | | | | |
| D | Kuraray ® Poval 26-88 | 5.4 | 5.4 | 5.4 | 5.4 |
| | MX 10 | | | | |
| I | Demineralized water | 46.73 | 46.72 | 46.73 | 46.15 |
| B | Desmodur ® N 3300 | 3.15 | | 3.15 | |
| E | Solvesso ® 200 ND | 21.89 | 32.28 | 32.27 | 32.85 |
| G | Citric acid anhydrous | 0.75 | 0.75 | 0.75 | 0.75 |
| F | Rhodopol ® G | 0.1 | 0.1 | 0.1 | 0.1 |

### Ex1

11 g Isocyanate (Desmodur® N 3300) plus 76,61 g Solvesso® 200 ND were mixed with 71,5 g Diflufenican and dispersed under gentle stirring. The water phase was prepared by mixing under stirring 18,9 g Kuraray® Poval 26-88 MX 10 and 138,6 g water.

The oil phase was added to the water phase, and then the emulsion was formed by using an UltraTurrax for 3 min at 18,000 U/min. The emulsion was transferred in a 3 necked flask and a solution of 6,93 g Diethylentriamine MX 50 plus 27,7 g water was added under stirring (500 U/min). The slurry was heated up at 50° C. and kept at this temperature for 4 h. The preparation was slowly cooled down, 0,3 g Rhodopol® G were added under stirring and finally pH was adjusted to 7,1 with 3,56 g citric acid anhydrous. A capsule suspension of diflufenican suspended in Solvesso® 200 ND was thus obtained with a loading of 200 g/L and a batch size of 1693,8 g, with a density of 1,085 gml-1 and 20,2% w/w (219.7 g/L) diflufenican content in form of a white odorless suspension.

### Ex2

110 g Isocyanate (Desmodur® 44 V 20 L TK 44.4) plus 1122,7 g Solvesso® 200 ND were mixed with 343,75 g Diflufenican and dispersed under gentle stirring. The water phase was prepared by mixing under stirring 189 g Kuraray® Poval 26-88 MX 10 and 1386 g water.

The oil phase was added to the water phase, and then the emulsion was formed by using an UltraTurrax for 3 min at 18,000 U/min. The emulsion was transferred in a 3 necked flask and a solution of 69,3 g Diethylentriamine MX 50 plus 277 g water was added under stirring (500 U/min). The slurry was heated up at 50° C. and kept at this temperature for 4 h. The preparation was slowly cooled down, 3,48 g Rhodopol® G were added under stirring and finally pH was adjusted to 7,5 with 26.25 g citric acid anhydrous (from 9,59). A capsule suspension of diflufenican suspended in Solvesso® 200 ND was thus obtained with a loading of 100 g/L and a batch size of 3500 g, with a density of 1,045 gml-1 and 9,61% w/w (100.4 g/L) diflufenican content in form of a white odorless suspension. The particle size D90 was 28.33 μm.

Ex2a: as Ex1, but with 175 g batch size.

### Ex3

110 g Isocyanate (Desmodur® N3300) plus 1122 g Solvesso® 200 ND were mixed with 343,75 g Diflufenican and dispersed under gentle stirring. The water phase was prepared by mixing under stirring 189 g Kuraray® Poval 26-88 MX 10 and 1386 g water. The oil phase was added to the water phase, and then the emulsion was formed by using an UltraTurrax for 3 min at 18,000 U/min. The emulsion was transferred in a 3 necked flask and a solution of 69,3 g Diethylentriamine MX 50 plus 277 g water was added under stirring (500 U/min). The slurry was heated up at 50° C. and kept at this temperature for 4 h. The preparation was slowly cooled down, 3,42 g Rhodopol® G were added under stirring and finally pH was adjusted to 6,89 with 18,59 g citric acid anhydrous. A capsule suspension of diflufenican suspended in Solvesso® 200 ND was thus obtained with a loading of 100 g/L and a batch size of 3500 g, with a density of 1,041 gml-1 and 9,89% w/w (102.9 g/L) diflufenican content in form of a white odorless suspension. The particle size D90 was 23,38 μm.

Ex3a: as Ex3 with 350 g batch size.

### Ex10

5,5 g Isocyanate (Desmodur® T 80 MX 73.4) plus 57 g SOLVESSO® 200 ND were mixed with 17,2 g Diflufenican and dispersed under gentle stirring. The water phase was prepared by mixing under stirring 9,45 g Kuraray® Poval 26-88 MX 10 and 69,3 g water.

The oil phase was added to the water phase, and then the emulsion was formed by using an UltraTurrax for 3 min at 18,000 U/min. The emulsion was transferred in a 3 necked flask and a solution of 3,46 g Diethylenetriamine MX 50 plus 13 g water was added under stirring (500 U/min). The slurry was heated up at 50° C. and kept at this temperature for 4 h. The preparation was slowly cooled down, 0,175 g Rhodopol® G were added under stirring and finally pH was adjusted to 6,7 with 1,31 g citric acid anhydrous. A capsule suspension of diflufenican suspended in Solvesso® 200 ND was thus obtained with a loading of 100 g/L and a batch size of 175 g, with a density of 1,045 gml-1 and 9,99% w/w (104.4 g/L) diflufenican content in form of a white odorless suspension. The particle size D90 was 42,46 μm.

TABLE 2

| | | Ex 1 | Ex 2a | Ex 3a | Ex 10 |
|---|---|---|---|---|---|
| OTW = Room | Particle size D90 in μm | 37.16 | 34.06 | 21.56 | 42.46 |
| temperature | w/o sonication | | | | |
| | Particle size D90 in μm | 34.75 | 20.49 | 20.20 | 26.6 |
| | w sonication | | | | |
| | Dyn. Visc. 20 1/s | 248 | 322 | 274 | 316 |
| | pH 100% | 7.1 | 6.9 | 6.8 | 6.7 |
| | Al content in % | 20.2 | 9.36 | 9.82 | 9.99 |
| 2 weeks | Particle size D90 in μm | 47.4 | 155.84 | 21.40 | 89.75 |
| 54° C. | w/o sonication | | | | |
| | Particle size D90 in μm | 35.17 | 23.71 | 20.27 | 30.76 |
| | w sonication | | | | |
| | Dyn. Visc. 20 1/s | 315 | 2133 | 298 | 448 |
| | pH 100% | 7.0 | 6.4 | 6.9 | 6.6 |
| | Al content in % | 20.3 | 9.38 | 9.76 | 10.1 |

D90 = in μm, 90 volume % of all particles lies below the stated diameter, CIPAC method CIPAC MT 187.

By using the method description above diflufenican capsule suspensions of different loading where prepared with an average D90 particle size of 20-50 μm.

Physical properties fresh and after two weeks 54° C. storage show no negative effects, the diflufenican formulations according to the invention are fully chemically stable.

Microscopic pictures of the capsules were taken indication that no crystals of diflufenican where present outside the shell core.

As for Ex1, where the capsules were highly loaded the formulation solidifies after some months storage at room temperature. Nevertheless, if a highly loaded formulation to be used within month is required, this is to be considered a good alternative.

Better quality was obtained in Ex2 and Ex3 with a lower loading, which remain fluid and flowable.

The resulting suspension according to the invention is storage-stable over a prolonged period. Even upon prolonged storage at high temperature the active substance A) shows no decomposition. The suspension according to the invention can be diluted with water to give a homogeneous suspension resulting in a stable spray solution. It has good activity against harmful plants while simultaneously being very well tolerated in crops of useful plants.

The storage stability of the formulations according to the instant invention manifests itself for example in the form of no decomposition of the active substance A) even upon storage at higher temperatures. The results in Table 2 show that the formulation according to the invention shows no degradation of diflufenican, acceptable viscosity and particle size variation (capsule shell) and no pH change.

TABLE 3
Comparative Examples with Diflufenican where
a capsule suspension did not form:

| Component in % w/w | Ex 4 | Ex 5 | Ex 6 |
|---|---|---|---|
| Diflufenican | 9.62 | 9.62 | 9.62 |
| Desmodur ® 44 V 20 L | 3.15 | 3.15 | 3.15 |
| Hexamethylenediamine MX 50 | 1.98 | 1.98 | 1.98 |
| Reax ® 88 A | 1.20 | | 1.20 |
| demineralized water | 51.78 | 51.78 | 51.78 |
| Reax ® 88 B | | 1.20 | |
| Solvesso ®200 ND | 32.27 | 32.27 | |
| Miglyol ® 812 N | | | 32.27 |

The use of Reax 88A or 88B—usually recommended with capsule suspensions resulted in complete flocculation or a yoghurt like viscous formulation. No proper emulsion could be formed, which is required for the interfacial polymerization reaction between Isocyanate and amine, regardless of the carrier used (no solubilization of diflufenican).

Capsule Suspensions prepared with Method A (1 h reaction time) or Method B (recipe details summarized in Table 4):

Ex7:

11 g Isocyanate (Desmodur® N 3300) plus 113 g Solvesso® 200 ND were mixed with 34,4 g Diflufenican and dispersed under gentle stirring. The water phase was prepared by mixing under stirring 18,9 g Kuraray® Poval 26-88 MX 10 and 138,6 g water.

The oil phase was added to the water phase, and then the emulsion was formed by using an UltraTurrax for 3 min at 18,000 U/min. The emulsion was transferred in a 3 necked flask and a solution of 6,93 g Diethylenetriamine MX 50 plus 27,7 g water was added under stirring (500 U/min). The slurry was heated up at 50° C. and kept at this temperature for 1 h. The preparation was slowly cooled down, 0,34 g Rhodopol® G were added under stirring and finally pH was adjusted to 6,29 with 3,9 g citric acid anhydrous. A capsule suspension of diflufenican suspended in Solvesso® 200 ND was thus obtained with a loading of 100 g/L and a batch size of 350 g, with 9,79% w/w diflufenican content in form of a white odorless suspension.

### Ex8

11 g Isocyanate (Desmodur® N 3200) plus 113 g Solvesso® 200 ND were mixed with 34,4 g Diflufenican and dispersed under gentle stirring. The water phase was prepared by mixing under stirring 18,9 g Kuraray® Poval 26-88 MX 10 and 138,6 g water.

The oil phase was added to the water phase, and then the emulsion was formed by using an UltraTurrax for 3 min at 18,000 U/min. The emulsion was transferred in a 3 necked flask and a solution of 6,93 g Diethylenetriamine MX 50 plus 27,7 g water was added under stirring (500 U/min). The slurry was heated up at 50° C. and kept at this temperature for 3,5 h, quench with aqueous ammonia and keep another 0,5 h. The preparation was slowly cooled down, 0,34 g Rhodopol® G were added under stirring and finally pH was adjusted to 6,96 with 3,9 g citric acid anhydrous. A capsule suspension of diflufenican suspended in Solvesso® 200 ND was thus obtained with a loading of 100 g/L and a batch size of 350 g, with a density of 1,044 gml-1 and 9,75% w/w (101.8 g/L) diflufenican content in form of a white odorless suspension.

### Ex9

11 g Isocyanate (Desmodur® N 3400) plus 113 g Solvesso® 200 ND were mixed with 34,4 g Diflufenican and dispersed under gentle stirring. The water phase was prepared by mixing under stirring 18,9 g Kuraray® Poval 26-88 MX 10 and 138,6 g water.

The oil phase was added to the water phase, and then the emulsion was formed by using an UltraTurrax for 3 min at 18,000 U/min. The emulsion was transferred in a 3 necked flask and a solution of 6,93 g Diethylenetriamine MX 50 plus 27,7 g water was added under stirring (500 U/min). The slurry was heated up at 50° C. and kept at this temperature for 3,5 h, quenched with aqueous ammonia and kept another 0,5 h. The preparation was slowly cooled down, 0,34 g Rhodopol® G were added under stirring and finally pH was adjusted to 6,96 with 3,9 g citric acid anhydrous. A capsule suspension of diflufenican suspended in Solvesso® 200 ND was thus obtained with a loading of 100 g/L and a batch size of 350 g, with a density of 1,042 gml-1 and 9,72% w/w (101.3 g/L) diflufenican content in form of a white odorless suspension. The particle size D90 was 42,46 μm.

TABLE 4
Prepared formulations with Method A, 1 h reaction time, or Method B:

| | Ex 7 | Ex 8 | Ex 9 |
|---|---|---|---|
| Component in % w/w | (Method A, 1 h) | (Method B) | (Method B) |
| diflufenican | 9.62 | 9.62 | 9.62 |
| Diethylentriamin MX 50 | 1.98 | 1.98 | 1.98 |
| Kuraray ® Poval 26-88 MX 10 | 5.40 | 5.40 | 5.40 |
| demineralized | 46.73 | 46.73 | 46.73 |
| Desmodur ® N 3300 | 3.15 | | |
| Desmodur ® N 3200 | | 3.15 | |
| Desmodur ® N 3400 | | | 3.15 |
| Solvesso ®200 ND | 32.27 | 32.27 | 32.27 |
| citric acid monohydrate | 0.75 | 0.75 | 0.75 |
| Rhodopol ®G | 0.1 | 0.1 | 0.1 |

TABLE 5

| | | Ex 7 | Ex 8 | Ex 9 |
|---|---|---|---|---|
| | | (Method A, 1 h) | (Method B) | (Method B) |
| OTW = Room | Particle size D90 in μm | 23.73 | 27.96 | 168.17 |
| temperature | w/o sonication | | | |
| | Particle size D90 in μm | 22.35 | 18.67 | 59.34 |
| | w sonication | | | |
| | Dyn. Visc. 20 1/s | 332 | 249 | 368 |
| | pH 100% | 6.3 | 6.8 | 7 |
| | Al content in % | 9.79 | 9.75 | 9.72 |
| 2 weeks | Particle size D90 in μm | | 34.38 | 163.21 |
| 54° C. | w/o sonication | | | |
| | Particle size D90 in μm | | 18.59 | 55.70 |
| | w sonication | | | |
| | Dyn. Visc. 20 1/s | | 287 | 374 |
| | pH 100% | | 7.2 | 7 |
| | Al content in % | | 9.75 | 9.72 |

In Ex8 and Ex9: the capsules are not round anymore, but bended, depending on the isocyanate structure. Hence, it has been shown, that not all isocyanates are giving ideal and suitable capsules, and/or the right size and distribution, as can be seen in Ex. 9.

In Ex 7, which was kept for only 1 h at 50° C. it is shown that, also with this short reaction time, tight capsules can be formed, while with 4 h one is sure the capsule wall is tight.

Examples where isoxaflutole is the active ingredient:

Ex11: Example of an isoxaflutole capsule suspension formulation, where isoxaflutole was previously micronized without a carrier to a particle size D90 of 5,93 μm:

11 g Isocyanate (Desmodur® N 3300) plus 111,3 g Solvesso® 200 ND were mixed with 35,32 g isoxaflutole micronized (air milled without a carrier to a particle size D90 of 5,93 μm) and dispersed under gentle stirring. The water phase was prepared by mixing under stirring 18,9 g Kuraray® Poval 26-88 MX 10 and 138,6 g water.

The oil phase was added to the water phase, and then the emulsion was formed by using an UltraTurrax for 3 min at 18,000 U/min. The emulsion was transferred in a 3 necked flask and a solution of 6,93 g Diethylenetriamine MX 50 plus 27,7 g water was added under stirring (500 U/min). The slurry was heated up at 50° C. and kept at this temperature for 4 h. The preparation was slowly cooled down, 0,33 g Rhodopol® G were added under stirring and finally pH was adjusted to 4,56 (from 9,68) with 3,92 g citric acid anhydrous. A capsule suspension of micronized isoxaflutole suspended in Solvesso® 200 ND was thus obtained with a loading of 100 g/L and a batch size of 350 g, with a density of 1,047 gml-1 and 8,69% w/w (90.96 g/L) isoxaflutole content in form of a white odorless suspension.

TABLE 6
Example of an isoxaflutole capsule suspension formulation, where
isoxaflutole was previously micronized without a carrier

Ex 11

Component in % w/w

| | |
|---|---|
| isoxaflutole | 10 |
| Diethylenetriamine MX | 1.98 |
| 50 | |
| Kuraray ® Poval 26-88 | 5.40 |
| MX 10 | |
| demineralized water | 46.28 |
| Desmodur ® N 3300 | 3.15 |
| Solvesso ®200 ND | 31.89 |
| citric acid anhydrous | 1.2 |
| Rhodopol ®G | 0.1 |

Physical Data:

| | | |
|---|---|---|
| OTW = Room | Particle size D90 | 46.9 |
| temperature | w/o sonication | |
| | Particle size D90 | 32.41 |
| | w sonication | |
| | Dyn. Visc. 20 1/s | 2.19 |
| | pH 100% | 4.6 |
| | Al content in % | 8.69 |
| 2 weeks | appearance | Hard sediment |
| 54° C. | | No analytical |
| | | check was done |
| 8 weeks | Particle size D90 | 45.76 |
| 40° C. | w/o sonication | |
| | Particle size D90 | 32.52 |
| | w sonication | |
| | Dyn. Visc. 20 1/s | 177 |
| | pH 100% | 4.2 |
| | Al content in % | 6.16 |

Examples of capsule suspensions where isoxaflutole was previously air milled with the aid of a carrier (Sipernat®22 S) to a WP95: different loading and different amounts prepared.

### Ex 13

9,45 g Isocyanate (Desmodur® N 3300) plus 81 g Solvesso® 200 ND were mixed with 44,7 g isoxaflutole WP 95 and dispersed under gentle stirring. The water phase was prepared by mixing under stirring 16,2 g Kuraray® Poval 26-88 MX 10 and 118,8 g water.

The oil phase was added to the water phase, and then the emulsion was formed by using an UltraTurrax for 3 min at 18,000 U/min. The emulsion was transferred in a 3 necked flask and a solution of 5,94 g Diethylenetriamine MX 50 plus 23,7 g water was added under stirring (500 U/min). The slurry was heated up at 50° C. and kept at this temperature for 4 h. The preparation was slowly cooled down, 0,3 g Rhodopol® G were added under stirring and finally pH was adjusted to 4,2 (from 9,72) with 3,65 g citric acid anhydrous. A capsule suspension of isoxaflutole carried onSipernat® 22S was thus obtained with a loading of 150 g/L (13% isoxaflutole) and a batch size of 300 g in form of a white odorless suspension.

### Ex14

94,5 g Isocyanate (Desmodur® N 3300) plus 953,1 g Solvesso® 200 ND were mixed with 303,6 g isoxaflutole WP 95 and dispersed under gentle stirring. The water phase was prepared by mixing under stirring 162 g Kuraray® Poval 26-88 MX 10 and 1190,4 g water.

The oil phase was added to the water phase, and then the emulsion was formed by using an UltraTurrax for 3 min at 18,000 U/min. The emulsion was transferred in a 3 necked flask and a solution of 59,4 g Diethylenetriamine MX 50 plus 237 g water was added under stirring (500 U/min). The slurry was heated up at 50° C. and kept at this temperature for 4 h. The preparation was slowly cooled down, 2,95 g Rhodopol® G were added under stirring and finally pH was adjusted to 4,2 (from 9,43) with 34,41 g citric acid anhydrous. A capsule suspension of isoxaflutole carried on Sipernat® 22S was thus obtained with a loading of 100 g/L and a batch size of 3000 g, with a density of 1,047 gml-1 and 7,73% w/w (80.91 g/L) isoxaflutole content in form of a white odorless suspension.

The same experiment (Ex16) was conducted with a 300 g batch size.

### Ex15

94,5 g Isocyanate (Desmodur® N 3300) plus 953,1 g Miglyol® 812 N were mixed with 303,6 g isoxaflutole WP 95 and dispersed under gentle stirring. The water phase was prepared by mixing under stirring 162 g Kuraray® Poval 26-88 MX 10 and 1190,4 g water.

The oil phase was added to the water phase, and then the emulsion was formed by using an UltraTurrax for 3 min at 18,000 U/min. The emulsion was transferred in a 3 necked flask and a solution of 59,4 g Diethylentriamin MX 50 plus 237 g water was added under stirring (500 U/min). The slurry was heated up at 50° C. and kept at this temperature for 4 h. The preparation was slowly cooled down, 2,95 g Rhodopol® G were added under stirring and finally pH was adjusted to 4,41 (from 9,63) with 31,49 g citric acid anhydrous. A capsule suspension of isoxaflutole carried on Sipernat® 22S was thus obtained with a loading of 100 g/L and a batch size of 3000 g, with a density of 1,035 gml-1 and 8,06% w/w (83.37 g/L) isoxaflutole content in form of a white odorless suspension.

The same experiment (Ex17) was conducted with a 300 g batch size.

TABLE 7
Examples of capsule suspensions where isoxaflutole
was previously air milled with the aid of a
carrier (Sipernat ®22 S) to a WP95:

| Component in % w/w | Ex 13 | Ex 14 | Ex 15 |
|---|---|---|---|
| isoxaflutole WP 95 | 14.90 | 10.12 | 10.12 |
| Diethylenetriamine MX | 1.98 | 1.98 | 1.98 |
| 50 | | | |
| Kuraray ® Poval 26-88 | 5.40 | 5.40 | 5.40 |
| MX 10 | | | |
| demineralized water | 46.28 | 46.28 | 46.38 |
| Desmodur ® N 3300 | 3.15 | 3.15 | 3.15 |
| Miglyol ® 812 N | | | 31.77 |
| Solvesso ®200 ND | 26.99 | 31.77 | |
| citric acid anhydrous | 1.2 | 1.2 | 1.1 |
| Rhodopol ®G | 0.1 | 0.1 | 0.1 |

TABLE 8
Comparison of physical data at start (OTW = fresh sample at
room temperature) and after storage two weeks 54° C.:

| | | | Ex 16 | Ex 17 |
|---|---|---|---|---|
| | | | (Ex 14 as | (Ex 15 as |
| | | | 300 g | 300 g |
| C | | Ex 13 | batch) | batch) |
| OTW = Room | Particle size D90 | 39.59 | 47.49 | 76.77 |
| temperature | w/o sonication | | | |
| | Particle size D90 | 28.95 | 32.3 | 42.22 |
| | w sonication | | | |
| | Dyn. Visc. 20 1/s | 236 | 409 | 506 |
| | pH 100% | 4.2 | 4.2 | 4.3 |
| | Al content in % | 13 | 8.56 | 8.56 |
| 2 weeks at | Particle size D90 | 40.68 | 77.36 | 113.38 |
| 54° C. | w/o sonication | | | |
| | Particle size D90 | 30.02 | 44.97 | 45.15 |
| | w sonication | | | |
| | Dyn. Visc. 20 1/s | 226 | 518 | 712 |
| | Al 11.4 content in % | 6.14 | 7.08 | |
| | pH 100% | 3.9 | 3.9 | 3.9 |

Comparing the formed capsule suspensions and the data from fresh sample versus stored at 54° C. for two weeks, or at 40° C. for four weeks, there are no severe abnormalities—pH, particle size D90 and viscosity are quite constant, showing unexpectedly low degradation (12 to 30%) of the active ingredient isoxaflutole.

Ex12: Example with Isoxaflutole where a capsule suspension did not form:

TABLE 9

| Component in % w/w | Ex 12 |
|---|---|
| isoxaflutole WP 95 | 10.12 |
| Desmodur N 3300 | 3.15 |
| Diethylenetriamine MX 50 | 1.98 |
| Kuraray ® Poval 26-88 MX 10 | 5.4 |
| demineralised water | 47.58 |
| Rapeseed oil methyl ester | 31.77 |

Same methodology as above was followed, but the final formulation had a yoghurt-like consistency.

Capsules with isoxaflutole, on a carrier or without, are different in shape versus these of diflufenican, not having a perfect round shape and having the surface rough and containing small holes.

1. A capsule suspension of an agrochemical active ingredient comprising a polyurea-shell and a core,
wherein the core comprises an active ingredient selected from the group consisting of diflufenican and isoxaflutole,
wherein the active ingredient is present in the form of suspended particles alone or on a solid carrier.

2. The capsule suspension according to claim 1, wherein the solid carrier is highly dispersed amorphous silicon dioxide.

3. The capsule suspension according to claim 1, wherein the capsule has an average particle size D90 of 1 to 60 μm.

4. The capsule suspension according to claim 1, wherein the capsule has a polyurea shell comprising a polyisocyanate and a polyamine in polycondensed form.

5. The capsule suspension according to claim 1, wherein the core further comprises a water-immiscible carrier.

6. The capsule suspension according to claim 5, wherein the water-immiscible carrier is selected from the group consisting of aromatic hydrocarbons, mineral oil, naphthaline free mineral oil, fatty acids glycerides, caprylic or capric triglycerides and neutral vegetable oil, as well as mixtures thereof.

7. An agrochemical comprising the capsule suspension according to claim 1, the formulation comprising:
a) diflufenican or isoxaflutole as active ingredient (optionally micronized or air milled with 5 wt % based on the amount of active ingredient and solid carrier, of a solid carrier, optionally highly dispersed, amorphous Silicon dioxide,
b) Polyisocyanate
c) Diethylentriamine as 50% solution in water
d) Polyvinylalcohol, about 88% saponified Polyvinylacetate
e) Liquid carrier, optionally selected from the group of aromatic hydrocarbons, a mixture of fatty acids glycerides, caprylic or capric triglycerides, and neutral vegetable oil
f) Rheological additives (optionally rheological modifier)
g) Poly organic acid (optionally polyprotic acid)
h) one or more Formulation auxiliaries (optionally other formulants, antifreeze, biocides, antifoam)
i) Demineralized water.

8. The agrochemical formulation according to claim 7 comprising:
a) 4 to 30 wt % of diflufenican or 4 to 30 wt % of isoxaflutole
b) 2-5 wt % of Polyisocyanate
c) 0.7-4 wt % Diethylentriamine as 50% solution in water
d) 3-10 wt % Polyvinylalcohol, about 88% saponified Polyvinylacetate
e) 10-45 wt % of a liquid carrier, optionally selected from the group of aromatic hydrocarbons, a mixture of fatty acids glycerides, caprylic or capric triglycerides, and neutral vegetable oil
f) 0.02-0.3 wt % of one or more rheological additives (optionally rheological modifier)
g) 0.4-4 wt % of a poly organic acid (optionally polyprotic acid)
h) 5-10 wt % of commonly used formulation auxiliaries (optionally other formulants, antifreeze, biocides, antifoam)
i) Demineralized water ad 100 wt %.

9. The agrochemical formulation according to claim 7 comprising:
a) 5 to 20 wt % of diflufenican or 5 to 20 wt % isoxaflutole,
b) 3.15 wt % of polyisocyanate,
c) 1.98 wt % diethylentriamine 50% solution in water,
d) 5.4 wt % polyvinylalcohol, ca. 88% saponified Polyvinylacetate
e) 20-35% Aromatic hydrocarbon,
f) 0.07 to 0.15 wt % of one or more rheological additives,
g) 0.7-2 wt % of a poly organic acid,
h) 7-9 wt % of commonly used formulation auxiliaries (optionally antifreeze, biocides, antifoam), and
i) demineralized water ad 100 wt %.

10. The agrochemical formulation according to claim 9, wherein component a) is optionally present from 5 to 10 wt %.

11. The agrochemical formulation according to claim 1, wherein the polyprotic acid is citric acid.

12. The agrochemical formulation according to claim 7, wherein the active ingredient adapted to be is used as WP comprising a solid carrier.

13. The agrochemical formulation according to claim 12, wherein the solid carrier is amorphous silicon dioxide.

14. A product comprising an agrochemical formulation according to claim 7 adapted for post-emergent application in soybean to reduce phytotoxicity.

15. A product comprising the capsule suspension according to claim 1 in an agrochemical formulation thereof adapted for post-emergent application in soybean to reduce phytotoxicity.

16. A process for preparation of the capsule suspension according to claim 1, wherein the active ingredient is pre-milled as before encapsulation.
